(19) United States
(12) Patent Application Publication
(10) Pub. No.: US 2016/0207701 A1
(43) Pub. Date: Jul. 21, 2016

(54) DRY GRANULAR MATERIAL FEEDER AND USE THEREOF

(71) Applicant: Active Minerals International, Sparks, MD (US)

(72) Inventors: Ryan W. ERNEST, JR., Macon, GA (US); Ronald J. BELL, Baltimore, MD (US); Paul FENDLEY, Cockeysville, MD (US); Steven B. FELDMAN, Cockeysville, MA (US); Rudolph COETZEE, Paxton, MA (US); Dennis C. PARKER, Sparks, MD (US); Robert J. PURCELL, Baltimore, MD (US)

(21) Appl. No.: 14/597,878

(22) Filed: Jan. 15, 2015

(51) Int. Cl. B65D 88/54; B01F 15/02; B65G 65/46

(52) U.S. Cl. CPC B65D 88/546; B65G 65/46; B01F 15/0235

(57) ABSTRACT

An apparatus and methods for feeding granular material are described, in the form of a frame with a leveler, a controller, and a feeder. The feeder includes a hopper, an enclosure with an outlet, a drive assembly electrically connected to the controller, and a rotatable member in communication with the drive assembly and configured to rotate within the enclosure to control a rate of flow of granular material from the hopper through the outlet.

### BACKGROUND

Controlling the rate of flow of granular material has importance in a number of applications. One such application is controlling the dosage of an additive to a granular composition such a dry-mix shotcrete or Gunite. Additives to such dry-mixes include liquid rheology modifiers, mix stabilizers, or combinations of both. No suitable method exists to dispense a dry granular additive material at a controlled dosage rate in Gunite applications.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry various features may not be drawn to scale and are used for illustration purposes only. In fact, the dimensions of the various features in the drawings may be arbitrarily increased or reduced for clarity of discussion.

FIG. 1 is a high level diagram of an apparatus for feeding granular material in accordance with one or more embodiments;

FIG. 2 is a high level diagram of a feeder in accordance with one or more embodiments;

FIG. 3 is an illustration of an inner wall of a feeder enclosure in accordance with one or more embodiments;

FIG. 4 is a high level diagram of a rotatable member in accordance with one or more embodiments;

FIG. 5 is a high level diagram of a feeder in accordance with one or more embodiments;

FIG. 6 is a high level diagram of an apparatus for feeding granular material in accordance with one or more embodiments;

FIG. 7A is a side view of a feeder application in accordance with one or more embodiments;

FIG. 7B is a front view of a feeder application in accordance with one or more embodiments;

FIG. 7C is a top view of a feeder application in accordance with one or more embodiments;

FIG. 8 is a method of dispensing granular material in accordance with one or more embodiments;

FIG. 9 is a method of controlling the dosage of an additive to an intermediate composition in accordance with one or more embodiments;

FIG. 10 is a block diagram of a controller usable in accordance with one or more embodiments; and

FIG. 11 is an apparatus sufficient for shotcrete, dry-mix (gunite) according to some embodiments.

### DETAILED DESCRIPTION

The accompanying drawings, which are incorporated in and constitute a part of this specification, illustrate one (several) embodiment(s) of the invention and together with the description, serve to explain the principles of the embodiments described herein.

Concrete applications use various forms of compositions. In some embodiments, the composition is chosen from concrete compositions (comprising a cementitious binder, aggregate, and water), cement pastes (comprising a cementitious binder and water), mortars (comprising a cementitious binder, water, and fine aggregates), and dry-mixtures thereof. In some embodiments, these compositions further comprise a dry granular material additive.

Shotcrete (also known by the trade name Gunite for dry mixtures) uses compressed air to shoot concrete onto (or into) a frame or structure. In some embodiments, shotcrete, dry-mix (gunite) includes placing concrete by a high pressure pneumatic projection from a nozzle. Shotcrete can be applied overhead or on vertical surfaces without forming. In some embodiments, shotcrete is used for concrete repairs or placement on bridges, transportation structure, viaducts, jersey barriers, road decks, dams, pools, and on other applications, which are typically costly or difficult. Shotcrete is, in some embodiments, applied against vertical soil or rock surfaces, or other applications lacking a formwork. In some embodiments, shotcrete is used for rock support, e.g., mountain tunneling. Shotcrete is, in some embodiments, used for minimizing seepage.

In some embodiments, a shotcrete method uses a dry mix or a wet mix. In some embodiments, the shotcrete, dry-mix (Gunite) method comprises adding a dry or substantially dry form of a composition noted herein into a machine and conveying the dry form of the composition, e.g., through a conduit, e.g., hoses, to an exit, e.g., a nozzle, with compressed air. The water sufficient for the hydration of the dry composition is added at or near the exit, e.g., the nozzle.

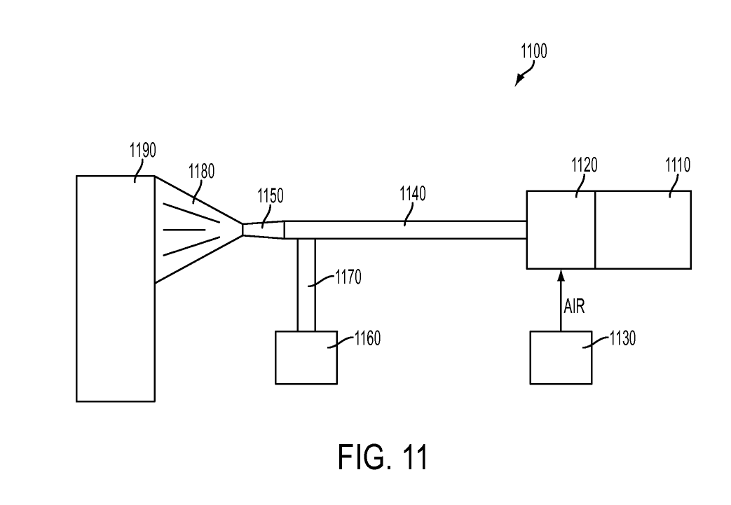

For example, FIG. 11 shows an apparatus 1100 sufficient for practicing a shotcrete, dry-mix (gunite) method. Mixer 1110 is sufficient to receive and mix dry or substantially dry components of the composition described herein (dry-mixture). The dry-mixture is transported to gun 1120, which is configured to receive air from compressor 1130 and to build up pressure sufficient to make the dry-mixture travel through conduit 1140 to nozzle 1150. At or near nozzle 1150 (in some embodiments, near the nozzle, ranges from 1 inch to 72 inches or from 6 inches to 48 inches or from 12 inches to 36 inches), the dry-mixture is wetted by water (and optionally liquid additive) from a water source 1160 via conduit 1170. The wetted composition (dry-mixture plus water and additives added via conduit 1170) is expelled in a pneumatic projection 1180 to a site 1190, where the wetted composition is allowed to consolidate. In the embodiment of FIG. 11, the shotcrete, dry-mix (gunite) is a method in which most of the mixing water is added to the dry-mixture at or near the nozzle 1150.

In a base form, the dry-mixture consists of a cementitious binder and aggregate. This base dry-mixture is typically mixed with one or more other substantially dry additives, e.g., silica fumes; admixtures, such as accelerators, air-entraining admixtures, water-reducing admixtures, high-range water-reducing admixtures; other ingredients, such as barite or zeolite; and attapulgite, such as Acti-Gel® 208. There are numerous such formulations, some of which are discussed in U.S. application Ser. No. 14/266,748, which is hereby incorporated herein by reference for all of the compositions disclosed therein.

Although practicable with other dry-mix compositions, the shotcrete, wet-mix and shotcrete dry-mix (gunite), in some embodiments uses a composition shown in the following table.

| | |
|---|---|
| Cementitious binder | 18-20% by weight of dry components |
| materials | |
| Attapulgite, e.g., | 0.01 to 4.00% by weight of the composition |
| Acti-Gel ® 208 | |
| Aggregate | ACl 506R-85 Table 2.1 Gradation No. 1, 2 or 3 |
| | ACI 506R Gradation 1 or 2 |
| | 1:1 to about 1:3 by weight of cementitious |
| | binder materials |
| Silica fume | (>90% SiO₂) less than 10% by weight of |
| | cementitious binder materials |
| Admixtures | Accelerator 2-5% by weight of cementitious |
| | binder materials |
| | Optional air-entraining admixture |
| | Optional water-reducing admixture |
| | Optional high-range water-reducing admixture |
| Water | 0.300% by weight for shotcrete, dry-mix |
| | (gunite) (W/C less than 0.3) (added, e.g., at or |
| | near the nozzle) |
| | (W/C greater than or equal to 0.35 and less |
| | than or equal to 0.45) |
| Other | Barite |
| | zeolite |

What is needed is an apparatus and method of volumetric dispensing of dry granular material into a concrete or shotcrete mixing operation with continuous or variable dosage control.

An apparatus for feeding granular material is configured to control the rate of flow of granular material useful for concrete applications, including shotcrete, wet-mix and shotcrete, dry-mix (gunite).

By controlling the rate of flow of an additive into a composition at the point of conveyance, the amount of additive dispensed into the composition can be adjusted as needed to maintain or change the overall makeup (and sometimes performance) of the granular composition.

In some embodiments, the granular material is an additive to a composition chosen from concrete compositions, cement pastes, mortars, and dry-mixtures thereof. In some embodiments, the granular material is a suitable additive for shotcrete, wet-mix or shotcrete, dry-mix (gunite).

In some embodiments, granular material is a rheology modifier for a dry-mix compound. In some embodiments, granular material is a mix stabilizer for a dry-mix compound. In some embodiments, granular material is a combination of a rheology modifier and a mix stabilizer for a dry-mix compound.

In some embodiments, the granular material is chosen from silica fumes; admixtures, such as accelerators, air-entraining admixtures, water-reducing admixtures, high-range water-reducing admixtures; other ingredients, such as barite or zeolite; and attapulgite, such as Acti-Gel® 208.

In some embodiments, the attapulgite is from a locality chosen from Palygorskaya, near the Popovka River, Perm, Russia; Attapulgus, Decatur Co., Georgia; at Tafraout, Morocco; and in the Hyderabad deposit, Andhra Pradesh, India. In some embodiments, the attapulgite is from Attapulgus, Decatur Co., Georgia. In some embodiments, the attapulgite is associated with other non-attapulgite minerals, such as montmorillonite, dolomite, calcite, talc, chlorite, quartz, and the like. In some embodiments, the attapulgite is substantially free of non-attapulgite minerals. Such purified attapulgite is, in some embodiments, available by using the methods in U.S. Pat. No. 6,444,601 and U.S. Pat. No. 6,130,179, each of which is incorporated herein in its entirety.

In some embodiments, granular material is Acti-Gel® 208 rheology modifier and mix stabilizer, available from ACTIVE MINERALS INTERNATIONAL, LLC. Acti-Gel® 208 is a low-dose rheology modifier and mix stabilizer that provides superior aggregate suspension, eliminates segregation, and dramatically improves the workability, flowability, pumpability, and performance of concretes including shotcrete and Gunite. Acti-Gel® 208 is a specific performance admixture formulated as a highly purified Mg-aluminosilicate (Mg,Al)₂Si₄O₁₀(OH).4(H₂O) that complies with ASTM C494 Type S standard specification for chemical admixtures for concrete.

Acti-Gel® 208 is manufactured as spray-dried beads that are easily dispersed into individual needle particles on mixing. When fully dispersed, Acti-Gel® 208 particles separate to form an internal ‘bird's nest’, gel-like microstructure in the paste that supports slightly higher yield stress and thixotropy. Benefits include high surface area (˜150 m²/g), high aspect ratio, relatively high interparticle forces, (complex surface+edge charge), many contact points, stress-supporting bonds between particles, and space-filling structure. Rheology modification provides greater ability to suspend both cement particles and aggregate, reduces segregation and bleed, and improves flowability.

The thixotropic property of Acti-Gel® 208 provides time-dependent, reversible behavior in which viscosity of a material decreases under conditions of shear, but quickly recovers to its original value when the shearing ceases. In a static state, the ‘birds-nest’ alignment increases yield stress and produces a very stable suspension. In a shear state, microstructure is altered, improving alignment in a flow direction, shear-thinning, workability, and pumpability.

In shotcrete, wet-mix, and shotcrete, dry-mix (gunite) applications, addition of Acti-Gel® 208 can provide superior cohesion, reduced rebound, silica fume elimination, higher lifts, thicker applications, lower pumping pressures, or low dust.

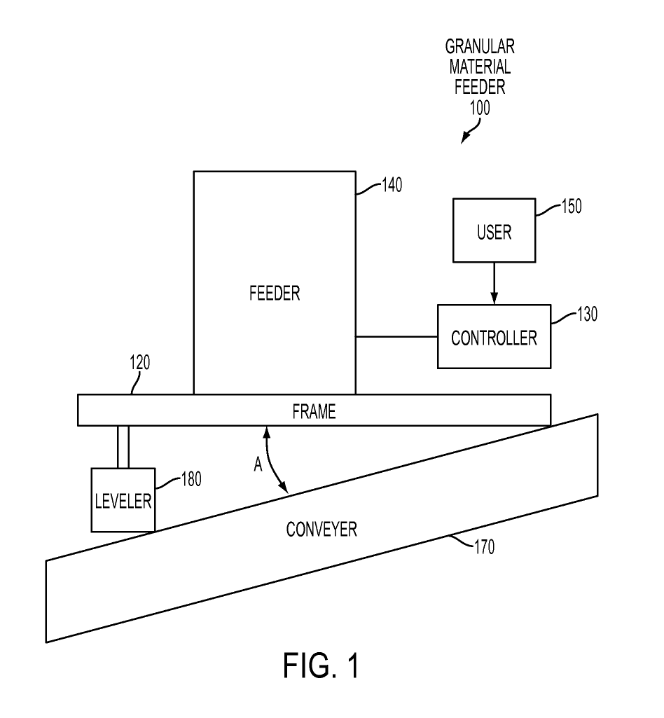

FIG. 1 is a diagram of an apparatus for feeding granular material in accordance with one or more embodiments. The granular material is added to an intermediate to a desired cement composition, cement paste, mortar, or dry mixture thereof that is a part of an application making the desired cement composition, cement paste, mortar, or dry mixture thereof. Granular material feeder 100 comprises frame 120, controller 130, feeder 140, and leveler 180.

Frame 120 is any rigid structure capable of supporting and stabilizing feeder 140, granular material, and additional hardware such as a lid and clamps. In some embodiments, frame 120 is sufficiently small and lightweight such that granular material feeder 100 is capable of being lifted by one or several people. In some embodiments, granular material feeder 100 weighs from about 50 pounds to about 150 pounds.

Frame 120 has any shape onto which feeder 140 can be attached, placed, or mounted such that the vertical alignment of feeder 140 is capable of being controlled. In some embodiments, all or a portion of frame 120 has any substantially planar shape. In some embodiments, all or a portion of frame 120 has a shape that is substantially square, rectangular, polygonal, triangular, or circular. In some embodiments, all or a portion of frame 120 is substantially h-shaped, comprising two parallel outer bars connected by two inner bars parallel to each other and perpendicular to the outer bars. In some embodiments, frame 120 comprises a single, central bar and outer bars perpendicular to the single, central bar.

In some embodiments, frame 120 has a length of about 12 inches to about 36 inches or about 15 inches to about 17 inches. In some embodiments, frame 120 has a width of about 12 inches to about 24 inches or about 15 inches to about 17 inches. In some embodiments, the length and width of frame 120 are substantially equal or different. In some embodiments, frame 120 is a substantially h-shaped structure with two inner bars separated by about 2 inches to about 14 inches or by about 3 inches to about 5 inches or about 10 to about 12 inches.

Frame 120 is made of any material or combination of materials with sufficient strength and rigidity to support and stabilize feeder 140, granular material, and additional hardware such as a lid and clamps. In some embodiments, frame 120 is made substantially of metal. In some embodiments, frame 120 is made substantially of steel bars. In some embodiments, frame 120 is made substantially of hollow steel bars having a square cross-section with sides of about 0.5 inch to about 2 inches or about 1 inch to about 1.5 inches. In some embodiments, frame 120 is made substantially of aluminum. In some embodiments, frame 120 is made of extruded aluminum framing members.

In some embodiments, frame 120 comprises leveler 180. In some embodiments, leveler 180 is separate from frame 120. In some embodiments, leveler 180 is any hardware piece, plurality of pieces, or assembly capable of altering the bottom profile of frame 120 such that, in operation, the orientation of frame 120 relative to an underlying surface is controllable. In some embodiments, all or a portion of frame 120 has any substantially planar shape and leveler 180 is any hardware extension away from the plane containing the substantially planar shape. In some embodiments, the hardware extension away from the plane is perpendicular to the plane. In some embodiments, the distance of the hardware extension away from the plane containing the substantially planar shape is adjustable. In some embodiments, the distance of the hardware extension away from the substantially planar shape ranges from about 0.5 inch to about 15 inches or from about 2 inches to about 12 inches.

In some embodiments, the hardware extension away from the plane containing the substantially planar shape includes a bar. In some embodiments, the distance from the bar to the plane is adjustable. In some embodiments, the bar is affixed to frame 120 through one or more bolts (not labeled). In some embodiments, the distance between the bar and the plane is capable of being adjusted such that, in operation, turning one or more adjustment nuts on one or more bolts causes the distance to either increase or decrease.

In some embodiments, frame 120 is a substantially h-shaped structure and leveler 180 comprises an additional bar similar or identical to an outer bar of frame 120. In some embodiments, an additional bar is affixed to an outer bar of frame 120 through two or more bolts (not labeled) perpendicular to the plane of the substantially h-shaped structure. In some embodiments, the distance between the additional bar and the substantially h-shaped structure is capable of being adjusted such that, in operation, turning one or more adjustment nuts on one or more bolts causes the distance to either increase or decrease.

In some embodiments, frame 120 and, if present, leveler 180, are configured to be positioned on conveyer 170. In some embodiments, conveyer 170 is a screw conveyor such as a truck auger. The conveyer 170 is used to transport an intermediate composition, i.e., an intermediate cement composition, cement paste, mortar, or mixture thereof, to which the granular material is added. In some embodiments, conveyer 170 is a truck auger configured to transport the intermediate (downstream) and both the intermediate and granular material (upstream). In some embodiments, conveyor 170 is a conduit and pump in which the granular material is added and thereafter transported (along with the intermediate) through mechanical pressure and/or gravity.

In some embodiments, frame 120 and, if present, leveler 180 are configured to be positioned on conveyer 170 with additional hardware (not shown). In some embodiments, frame 120 and, if present, leveler 180 are configured to be positioned on conveyer 170 with one or more clamps (not shown). In some embodiments, the positioning makes it practical to add the granular material to the conveyer 170.

In some embodiments, the topmost components of conveyer 170 are not level. In some embodiments, frame 120 and leveler 180 are configured such that, in operation, based on leveler 180 adjustments, substantially planar frame 120 is level while frame 120 and leveler 180 are positioned on non-level conveyer 170. In some embodiments, the topmost components of conveyer 170 have an angle A with respect to a horizontal axis of about zero degrees to about 35 degrees, or from about 0 degrees to about 20 degrees.

To support multiple orientations of feeder 140 with respect to conveyor 170, in some embodiments, frame 120 and leveler 180 are configured so that leveler 180 is capable of extending from substantially planar frame 120 at multiple locations on frame 120.

Controller 130 is any assembly configured with a power input and a controllable electrical output, with the electrical output determined by input from user 150. In some embodiments, power input is a standard power input such as 120 Volts AC or 240 Volts AC at 50 Hertz or 60 Hertz. In some embodiments, power input is supplied through a standard plug and power cord. In some embodiments, electrical output is a DC voltage within a range of about 0 Volts to about 210 Volts and a current of about 0.15 Amperes to about 10 Amperes. In some embodiments, electrical output is an AC voltage. In some embodiments, controller 130 comprises a transformer to alter AC power or a rectifier to convert to AC or DC output. In some embodiment, power is supplied by a generator.

In some embodiments, input from user 150 is received through a power switch and/or one or more knobs or other input devices including, but not limited to, buttons, touch pads, or touch screens, or through wired or wireless electronic communication interfaces. In various embodiments, in operation, input from user 150 determines electrical output of controller 130 and comprises setting switches, adjusting knobs, pressing buttons, touching a screen or pad, or any other interface control capable of determining an electrical output of controller 130.

In some embodiments, controller 130 output is electrically connected to feeder 140 through one or more cords (not labeled). In some embodiments, controller 130 output is electrically connected to feeder 140 through a single cord comprising two cord segments joined by a quick-connect connector.

Feeder 140 is any electromechanical assembly configured to receive controller 130 output and, in operation, provide continuous control of granular material flow through rotation of a rotatable member in an enclosure. In some embodiments, feeder 140 is secured to frame 120. In some embodiments, feeder 140 is secured to frame 120 by any combination of bolts, nuts, screws, rivets, clamps, clasps, welds, or any other temporary or permanent securing hardware. To support multiple orientations of feeder 140 with respect to conveyor 170, in some embodiments, frame 120 and feeder 140 are configured so that feeder 140 is capable of being secured to frame 120 having multiple orientations with respect to frame 120.

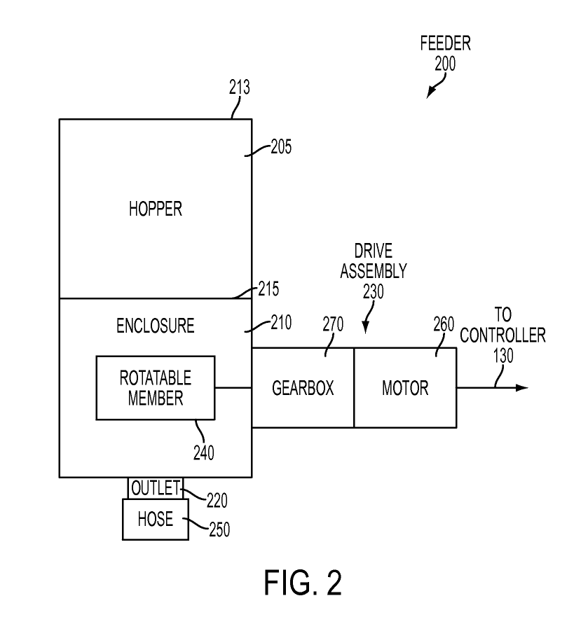

FIG. 2 is a diagram of feeder 200 in accordance with one or more embodiments. In some embodiments, feeder 200 is feeder 140 of granular material feeder 100. Feeder 200 comprises hopper 205, enclosure 210, drive assembly 230, and rotatable member 240.

Hopper 205 is any container with top opening 213, optionally sloped sides, and bottom opening 215, and capable of holding a quantity of granular material such that, in operation, the force of gravity or mechanical pressure causes the material to move down the optionally sloped sides and through bottom opening 215. In some embodiments, top opening 213 has a round, triangular, square, or polygonal shape. In some embodiments, bottom opening 215 has a round, triangular, square, or polygonal shape. In some embodiments, top opening 213 and bottom opening 215 have the same or different shapes. In some embodiments, bottom opening 215 comprises a substantially cylindrical extension of a round, triangular, square, or polygonal shape.

In some embodiments, top opening 213 has a circumference or perimeter of about 40 inches to about 120 inches, or from about 76 inches to about 80 inches. In some embodiments, bottom opening 215 has a circumference or perimeter of about 4 inches to about 28 inches, or from about 8 inches to about 12 inches. In some embodiments, sloped sides of hopper 205 form an angle with a horizontal axis of about 40 degrees to about 80 degrees, or from about 50 degrees to about 70 degrees. In some embodiments, hopper 205 has a height of about 10 inches to about 24 inches, or from about 14 inches to about 16 inches. In some embodiments, hopper 205 has a volume from about 300 cubic inches to about 7,200 cubic inches, or from about 2,000 cubic inches to about 2,400 cubic inches.

Hopper 205 is made of any material or combination of materials capable of supporting the weight of a full load of granular material. In some embodiments, the weight of a full load of granular material is from about 10 pounds to about 250 pounds, or from about 70 pounds to about 90 pounds. In some embodiments, hopper 205 is made of metal. In some embodiments, hopper 205 is made of stainless steel. In some embodiments, hopper 205 is made of high density polyethylene (HDPE).

In some embodiments, a lid (not shown) covers the top opening of hopper 205 to inhibit or substantially prevent contamination of granular material in hopper 205. The lid is made of any material capable of inhibiting or substantially preventing moisture and/or other contaminants from mixing with the granular material. In some embodiments, the lid is made of plastic. In some embodiments, the lid is a polycarbonate lid.

Enclosure 210 comprises any combination of one or more rigid components configured to support drive assembly 230 and contain rotatable member 240 such that rotatable member 240 is capable of rotating within enclosure 210. In some embodiments, drive assembly 230 is external to enclosure 210. In some embodiments, drive assembly 230 is internal to enclosure 210.

Enclosure 210 is made of any material or materials capable of supporting drive assembly 230, rotatable member 240, and, in various embodiments, hopper 205, granular material, and other hardware. In some embodiments, enclosure 210 is made substantially of metal. In some embodiments, enclosure 210 is made substantially of steel.

In some embodiments, enclosure 210 is configured from one or more components assembled to form an overall rigid structure. The various components are joined by any combination of bolts, nuts, screws, rivets, clamps, clasps, welds, or any other temporary or permanent securing hardware.

In some embodiments, enclosure 210 comprises outlet 220. Outlet 220 is any structure or combination of structures capable of directing a flow of granular material out of enclosure 210 due to the force of gravity or mechanical pressure. In some embodiments, the lower end of outlet 220 has a cylindrical shape. In some embodiments, the lower end of outlet 220 has a cylindrical shape with a cross-sectional inner diameter of about 1 inch to about 5 inches, or about 2 inches to about 3 inches. In some embodiments, outlet 220 is separate from other enclosure components. In some embodiments, outlet 220 is formed as part of one or more enclosure components configured for other functions.

In some embodiments, feeder 200 further comprises hose 250. Hose 250 is any structure capable of being fixed to outlet 220 and further directing a flow of granular material under the force of gravity or mechanical pressure. In some embodiments, hose 250 is a tube-shaped structure with a cylindrical cross-section. In some embodiments, hose 250 is made of a material that is easily cut to adjust the length of hose 250. In some embodiments, hose 250 is made of plastic or steel, such as stainless steel. In some embodiments, hose 250 is fixed to outlet 220 by a clamp (not shown). In some embodiments, the hose has a length ranging from ¼ to 30 feet or from 10 to 25 feet or from 15 to 20 feet. In some embodiments, the hose is configured to receive water (and optional additives) at or near to outlet, e.g., 3 feet, 2 feet, 1 foot or 6 inches therefrom. In some embodiments, the flow is directed to the conveyor 170.

Drive assembly 230 comprises motor 260, and in some embodiments, gearbox 270. Motor 260 is any motor capable of receiving the electrical output of controller 130 and varying a rate of rotation of a mechanical load based on the received electrical output. In some embodiments, gearbox 270 comprises the mechanical load. In some embodiments, motor 260 is an electric motor. In some embodiments, motor 260 is a DC electric motor and powered and controlled though controller 130 output. In some embodiments, motor 260 is an AC electric motor and powered and controlled though controller 130 output.

In some embodiments, drive assembly 230 comprises gearbox 270. Gearbox 270 is any hardware assembly capable of presenting a mechanical load to motor 260 through a rotating input element and driving a mechanical load through a rotating output element. In some embodiments, the rate of rotation of the rotating input element is the same or different from the rate of rotation of the rotating output element.

In some embodiments, drive assembly 230 is secured to enclosure 210 by any combination of bolts, nuts, rivets, screws, clamps, clasps, welds, or any other temporary or permanent securing hardware.

Feeder 200 further comprises rotatable member 240. In some embodiments, rotatable member 240 is a cylindrically shaped component having an axis of rotation along its center. In various embodiments, rotatable member 240 is in communication with either motor 260 or gearbox 270 of drive assembly 230 such that, in operation, rotatable member 240 rotates about the axis of rotation at a rate of rotation equal to that of the output of motor 260 or gearbox 270. In some embodiments, rotatable member 240 is an auger or worm. In some embodiments, the rotatable member 240 has a length ranging from 0.5 to 3 feet or from 1 to 2.5 feet. In some embodiments, rotatable member 240 rotates at a rate sufficient to keep a constant flow of granular material. In some embodiments, the flow rate is adjustable.

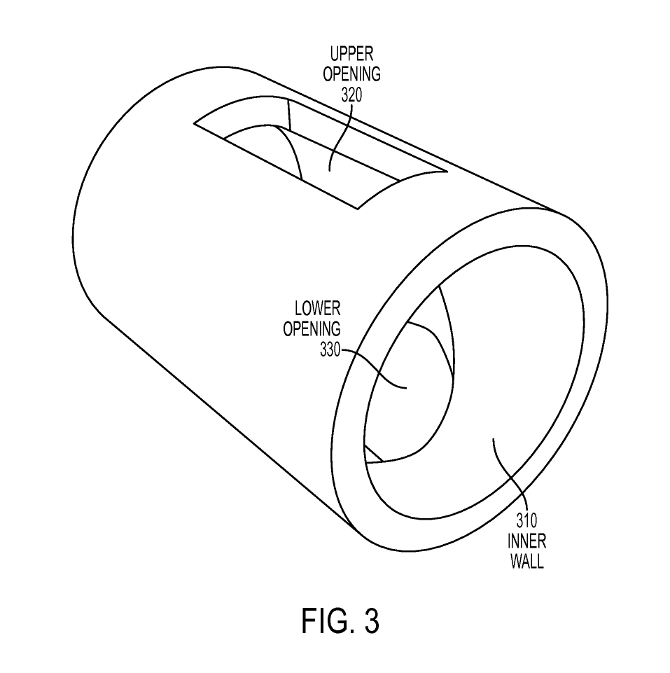

FIG. 3 is a diagram illustrating an inner wall 310 of enclosure 210 in accordance with one or more embodiments. In various embodiments, inner wall 310 is a surface of any one or more components of enclosure 210 that has a cylindrical shape and a hollow interior configured to accommodate rotatable member 240.

In operation, rotatable member 240 rotates within inner wall 310 at a rate of rotation determined by the output of drive assembly 230. As described below, the rate of rotation determines a rate of flow of granular material from hopper 205 above enclosure 210 to outlet 220 at the bottom of enclosure 210. In some embodiments, the rate of flow of granular material ranges from 0 cubic feet per hour to 4.0 cubic feet per hour or 0.5 cubic feet per hour to 3.0 cubic feet per hour or 1.5 cubic feet per hour to 2.5 cubic feet per hour.

In some embodiments, inner wall 310 comprises upper opening 320. Upper opening 320, enclosure 210, and hopper 205 are configured such that, in operation, granular material flows from hopper 205 through upper opening 320 under the force of gravity or mechanical pressure. In some embodiments, upper opening 320 has a substantially rectangular shape. In some embodiments, upper opening 320 has a substantially rectangular shape with a length parallel to the cylinder axis of about 1 inch to about 4 inches, or about 2 inches to about 3 inches. In some embodiments, upper opening 320 has a substantially rectangular shape with a width of about 0.5 inch to about 1.5 inches.

In some embodiments, inner wall 310 comprises lower opening 330. Lower opening 330, enclosure 210, and outlet 220 are configured such that, in operation, granular material flows through lower opening 330 and outlet 220 under the force of gravity or mechanical pressure. In some embodiments, lower opening 330 has a substantially circular shape with a diameter of about 2 inches to about 3 inches.

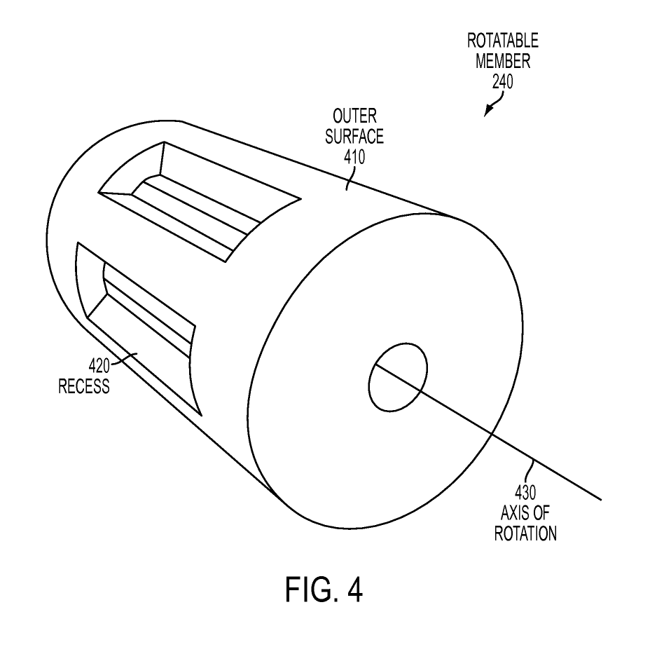

FIG. 4 is a diagram of rotatable member 240 in accordance with one or more embodiments. Rotatable member 240 comprises cylindrical outer surface 410 configured to fit inside inner wall 310 of enclosure 210. In some embodiments, outer surface 310 and inner surface 410 correspond to a cylinder with a diameter of about 1 inch to about 5 inches, or 2 inches to about 2.5 inches. In some embodiments, outer surface 410 and inner wall 310 correspond to a cylinder with a length of about 2 inches to about 8 inches, or about 3 inches to about 5 inches. Rotatable member 240 further comprises axis of rotation 430, about which rotatable member 240 rotates, in operation.

Rotatable member 240 further comprises one or more recesses 420 within outer surface 410. Recess 420 is an indentation in outer surface 410, thereby being configured to contain a volume of granular material based on the dimensions of recess 420. In various embodiments recess 420 can have any shape and size consistent with containing a predetermined quantity of granular material. In some embodiments, recess 420 is an oblong indentation oriented along axis of rotation 430. The rotational rate is related to the flow of granular material.

In some embodiments, recess 420 is an oblong indentation having a length parallel to axis of rotation 430 of about 1 inch to about 4 inches, or about 2 inches to about 3 inches. In some embodiments, recess 420 is an oblong indentation having a width of about 0.5 inch to about 1.5 inches. In some embodiments, recess 420 is an oblong indentation having a depth of about 0.125 inches to about 0.5 inches. In some embodiments, rotatable member 240 comprises three to ten, or five to seven recesses 420 distributed substantially equally around outer surface 410.

In some embodiments, upper opening 320 and rotatable member 240 are configured such that the one or more recesses 420 align with upper opening 320 at one or more angles of rotation about axis of rotation 430. At each of the one or more angles of rotation, granular material is thereby allowed to flow into the one or more recesses 420 under the force of gravity or mechanical pressure.

In some embodiments, lower opening 330 and rotatable member 240 are configured such that the one or more recesses 420 align with lower opening 330 at one or more angles of rotation about axis of rotation 430. At each of the one or more angles of rotation, granular material is thereby allowed to flow out of the one or more recesses 420 under the force of gravity or mechanical pressure.

In operation, rotatable member 240 rotates about axis of rotation 430 at a rate of rotation determined by the output of drive assembly 230. At each angle of rotation at which a given recess 420 aligns with upper opening 320, granular material flows into the recess 420 from hopper 205. At each angle of rotation at which a given recess 420 aligns with lower opening 330, granular material flows out of the recess 420 through outlet 220. As rotatable member 240 rotates about axis of rotation 430, a volume of granular material is transported in each recess 420 from upper opening 320 to lower opening 330.

In operation, the number and size of the one or more recesses 420 and the rate of rotation of rotatable member 240 thereby define a maximum rate of flow of granular material from hopper 205 to outlet 220. For a given configuration, the rate of rotation of rotatable member 240 controls the maximum rate of flow of granular material. In practice, various factors, such as the presence of moisture or other contaminants, can cause the actual rate of flow of granular material to be less than the maximum otherwise defined.

In some embodiments, the rotation rate of member 240 ranges from 0.1 to 175 rpm or 3 to 80 rpms or from 10 to 50 rpms or from 20 to 35 rpms.

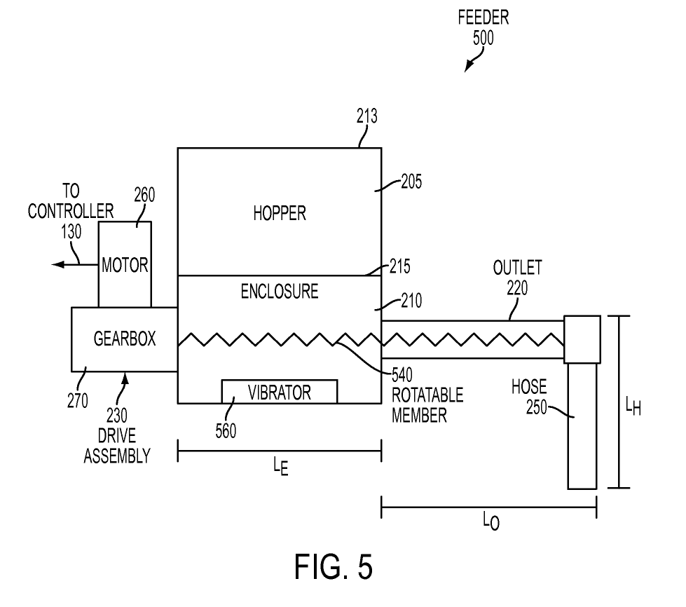

FIG. 5 is a diagram of feeder 500 in accordance with one or more embodiments. Like elements have like reference numbers. In some embodiments, feeder 500 is feeder 200. Feeder 500 comprises hopper 205, outlet 220, enclosure 210, hose 250, drive assembly 230, motor 260, controller 130, gear box 270, rotatable member 540, and vibrator 560.

Outlet 220 is on a side of enclosure 210. Outlet 220 has a length L₀ which allows for an additional length of mixing beyond the length of the enclosure L_{E} defined by the length of the rotatable member 540 in the enclosure 210 and outlet 220. Outlet 220 is any structure or combination of structures capable of directing the flow of granular material out enclosure 210 due to gravity or mechanical pressure. In some embodiments, outlet 220 is a horizontally oriented structure and has a cylindrical shape. In some embodiments, a first end of outlet 220 is attached to a sidewall of enclosure 210 and a second end of outlet 220 extends outward to define an outlet length L₀. In some embodiments, the outlet length L₀ ranges from about 9 inches to about 19 inches. In some embodiments, outlet 220 has a cylindrical shape with a cross-sectional outer diameter of about ½ inches to about 5 inches, or about ¾ inches to about 2.5 inches. In some embodiments, outlet 220 comprises an elbow-shaped end-piece configured to re-direct the flow of granular material, e.g., in a downward direction. In some embodiments, the lower end of the end-piece of outlet 220 has a cylindrical shape with a cross-sectional inner diameter of about 1 inch to about 5 inches or about 2 inches to about 3 inches.

Feeder 500 further comprises hose 250. Hose 250 has a length L_{H} sufficient to provide additional mixing beyond the length L₀ or L₀+L_{E}. In some embodiments, L_{H} ranges from 6 to 50 inches or from 10 to 40 inches or from 20 to 30 inches. In some embodiments, the hose 250 is positioned over conveyor 170 so that granular material is addable to the intermediate composition in the concrete.

Rotatable member 540 is any rotatable hardware component capable of applying a lateral force to a granular material when rotated, in operation. In some embodiments, rotatable member 540 is a screw or auger. In some embodiments, a screw is any generally helically shaped, rigid component that, in operation, translates rotation about an axis of rotation into lateral movements along grooves or spaces between one or more blades. In some embodiments, rotatable member 540 has a width that ranges from about ½ inch to about 2 inches. The width is sufficient to be accommodated and received by outlet 220. As noted above, the length of rotatable member 540 is L_{E}+L₀, i.e., the length in enclosure 210 (L_{E}) plus the length in outlet 220 (L₀) containing rotatable member 540.

In operation, rotatable member 540 is driven to rotate about its axis of rotation by drive assembly 230. Drive assembly 230 is described above with reference to feeder 200 and comprises motor 260 and gearbox 270. In some embodiments, drive assembly 230 further comprises additional hardware for coupling the output of gearbox 270 to rotatable member 540. In some embodiments, a separate coupler assembly (not shown) is positioned between gearbox 270 and rotatable member 540. In some embodiments, a separate coupler assembly is positioned inside enclosure 210. In some embodiments, a separate coupler assembly is positioned outside enclosure 210.

Drive assembly 230 is positioned adjacent to enclosure 210 and opposite outlet 220. Rotatable member 540 spans enclosure 210 from drive assembly 230 to outlet 220. In some embodiments, rotatable member 540 extends within outlet 220 to allow further mixing. In some embodiments, rotatable member 540 extends within outlet 220 along the entire length of outlet 220. In some embodiments, rotatable member 540 extends within outlet 220 up to 70, 80 or 90% of the distance to the end-piece of outlet 220.

In operation, rotatable member 540 rotates about its axis of rotation at a rate of rotation determined by the output of drive assembly 230. As rotatable member 540 rotates, granular material flows into outlet 220 from enclosure 210 and hopper 205. In some embodiments, the granular material flows to conveyer 170.

In operation, the size, shape, and rate of rotation of rotatable member 540 thereby define a maximum rate of flow of granular material from hopper 205 to outlet 220. For a given configuration, the rate of rotation of rotatable member 540 alters the rate of flow of granular material. In practice, various factors, such as moisture, grain size, grain composition, or other factors, alters the actual rate of flow of granular material.

In some embodiments, the rotation rate of rotatable member 540 ranges from 1 rpm to 175 rpm or from 5 to 120 rpm or from 10 to 35 rpm.

Feeder 500 further comprises vibrator 560. Vibrator 560 is any electromechanical assembly capable of causing vibrational movement of granular material within hopper 205, enclosure 210, or outlet 220. Vibrator 560 is at the base of enclosure 210, in some embodiments, vibrator 560 is at a side of enclosure 210 (say the side with the outlet 220). In operation, in some embodiments, vibrational movement of granular material reduces the effects of moisture and clumping of granular material. In some embodiments, vibrator 560 is not present.

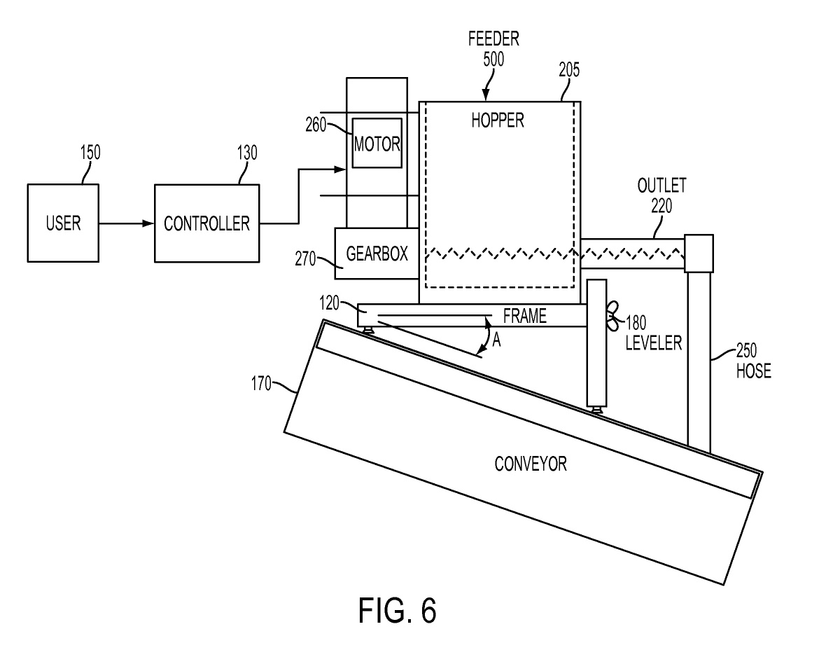

FIG. 6 is a diagram of an apparatus for feeding granular material comprising feeder 500 in accordance with one or more embodiments. Feeder 500 comprises hopper 205 and is supported by frame 120, which rests on conveyor 170. Leveler 180 extends downward from frame 120 to contact conveyor 170, which has a top surface that forms angle A with frame 120. Leveler 180 is configured to extend a sufficient length from substantially planar frame 120 so that the plane of frame 120 is, e.g., horizontal.

In the embodiment depicted in FIG. 6, outlet 220 extends from feeder 500 in a direction corresponding to the downward slope of conveyor 170, and hose 250 extends downward from outlet 220 toward conveyor 170. In operation, outlet 220 and hose 250 guide granular material into conveyor 170. In some embodiments, outlet 220 extends from feeder 500 in a direction corresponding to the upward slope of conveyor 170. In some embodiments, hose 250 is not present and, in operation, outlet 220 guides granular material into conveyor 170.

In the embodiment depicted in FIG. 6, motor 260 and gearbox 270 are external to feeder 500. In some embodiments, controller 130 is separated from feeder 500 by a distance of about 5 feet to about 15 feet. In some embodiments, controller 130 is separated from feeder 500 by a distance of about 6 feet to about 10 feet.

In operation, controller 130 receives input from user 150 and generates electrical output based on the input from user 150. Motor 260 is configured to receive the electrical output from controller 130 and turn at a rate of rotation that determines the rate of flow of granular material from hopper 205 through outlet 220 and into conveyor 170, as described above for feeder 500.

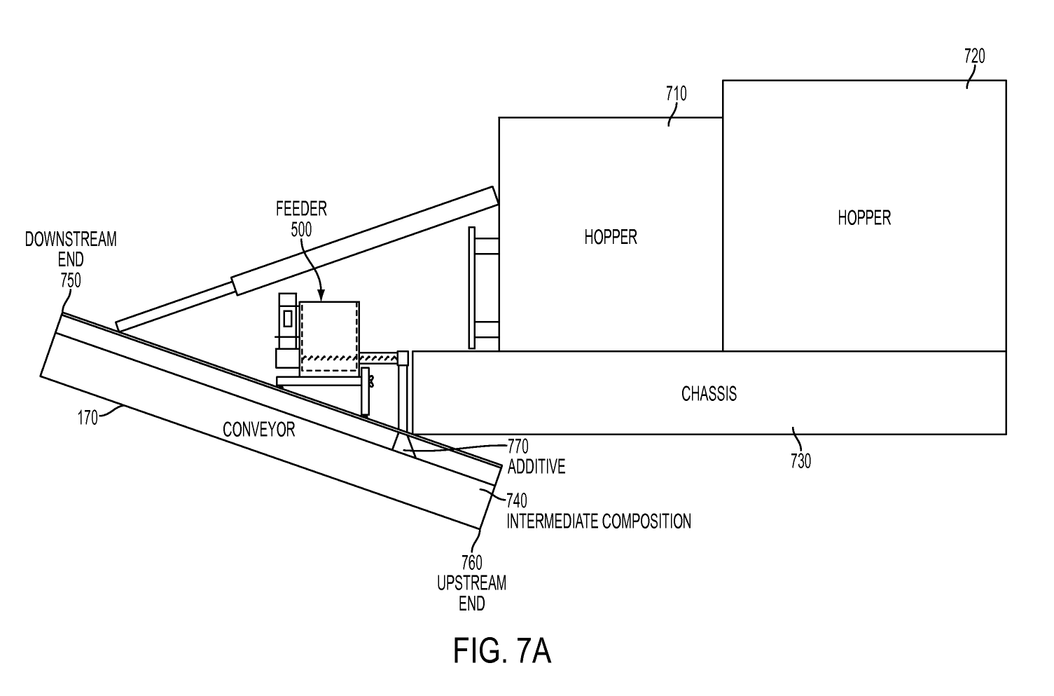

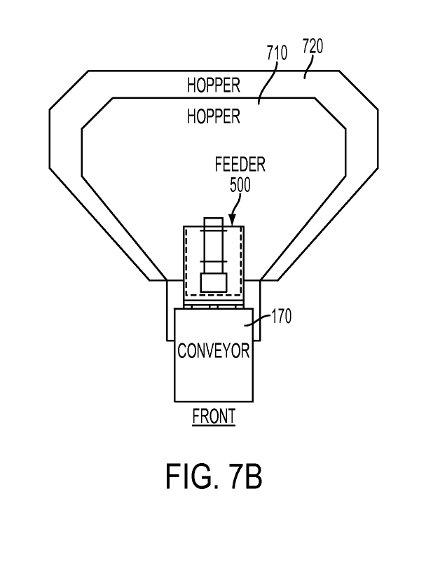

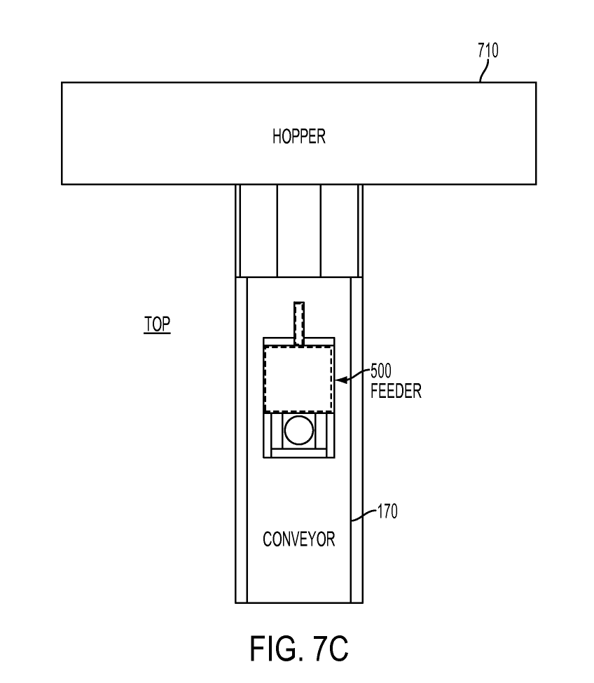

FIG. 7A is a side view of an application of feeder 500 in accordance with one or more embodiments. In the embodiment depicted in FIG. 7A, a first hopper 710 and a second hopper 720 are supported on chassis 730. Feeder 500 is positioned on conveyor 170, which has downstream end 750 and upstream end 760. In the embodiment depicted in FIG. 7A, downstream end 750 is at a higher elevation than upstream end 760. In some embodiments, downstream end 750 and upstream end 760 are at the same elevation and conveyor 170 is substantially level. In some embodiments, downstream end 750 is at a lower elevation than upstream end 760.

In some embodiments, first hopper 710 contains dry cementitious binder and second hopper 720 contains aggregates. In some embodiments, first hopper 710 contains aggregates and second hopper 720 contains dry cementitious binder. In some embodiments, second hopper 720 is not present and first hopper 710 contains cementitious binder and aggregates.

In some embodiments, chassis 730 is part of a mobile carrier such as a truck or trailer. In some embodiments, chassis 730 is a stationary support structure.

In operation, in some embodiments, the contents of first hopper 710 and second hopper 720 are mixed together to form an intermediate composition 740. In some embodiments, the intermediate composition 740 is a shotcrete, dry-mix (gunite) composition. The intermediate composition flows upstream where it is mixed with additive 770, the dry granular material, such as Acti-Gel® 208.

In some embodiments, in operation, intermediate composition 740 is formed by mixing at or near upstream end 760 of conveyor 170. Conveyor 170, in operation, applies mechanical force to intermediate composition 740 to cause intermediate composition to move from upstream end 760 to downstream end 750. In some embodiments, in operation, conveyor 170 comprises a screw or auger that applies mechanical force that moves intermediate composition 740 from upstream end 760 to downstream end 750 and also acts to mix intermediate composition 740 and additive 770 (once added). In some embodiments, the length of the conveyor 170 is sufficient to ensure homogeneous mixing of the intermediate composition 740 and additive 770 (once added). In some embodiments, the length is 5 to 12 feet or from 6 to 10 feet or from 7 to 9 feet.

In the embodiment depicted in FIG. 7A, feeder 500 is positioned closer to upstream end 760 than to downstream end 750. In operation, feeder 500 outputs granular material, additive 770, into conveyor 170. In some embodiments, feeder 500 outputs additive 770 into conveyor 170 at or near upstream end 760. In some embodiments, in operation, conveyor 170 acts to mix additive 770 and intermediate composition 740 while transporting additive 770 and intermediate composition 740 from upstream end 760 to downstream end 750. In some embodiments, conveyor 170 comprises a screw or auger that, in operation, acts to mix additive 770 and intermediate composition 740 while transporting additive 770 and intermediate composition 740 from upstream end 760 to downstream end 750.

In some embodiments, a nozzle (not shown) is positioned at or near downstream end 750. In some embodiments, in operation, water is added to additive 770 and intermediate composition 740 at or near the nozzle, and the water, additive 770, and intermediate composition 740 are propelled through the nozzle by a mechanical force to the site of application.

FIG. 7B is a front view of an application of feeder 500 in accordance with one or more embodiments.

FIG. 7C is a top view of an application of feeder 500 in accordance with one or more embodiments.

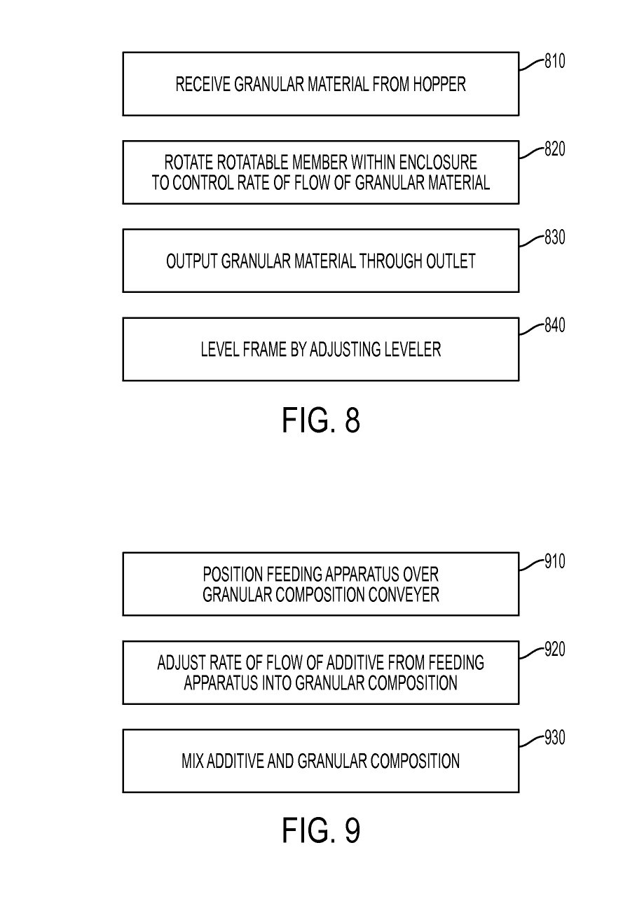

The present description also concerns methods of dispensing granular material. An example embodiment of a method of dispensing granular material is depicted in FIG. 8. Various embodiments include some or all of the operations depicted in FIG. 8.

In operation 810, a feeder optionally secured to a frame receives granular material from a hopper. In some embodiments, receiving the granular material comprises allowing material to flow from the hopper into one or more recesses on a cylindrical outer surface of a rotatable member through an aligned upper opening in an inner wall of an enclosure of the feeder. In some embodiments, receiving the granular material comprises allowing material to flow from a hopper into an enclosure comprising a rotatable member.

In operation 820, the rotatable member is rotated by a drive assembly to control a rate of flow of granular material from the hopper. In some embodiments, the rate of flow of granular material is controlled by the rate of rotation of a drive assembly motor in communication with the rotatable member and controlled by a controller. In some embodiments, the rate of rotation controlled by the controller is determined by manual input from a user. In some embodiments, rotating a rotatable member to control the rate of flow comprises rotating a screw.

In operation 830, granular material is outputted through an outlet in the enclosure of the feeder. In some embodiments, outputting granular material comprises allowing granular material to flow from the one or more recesses into the outlet through an aligned lower opening in the inner wall of the enclosure of the feeder. In some embodiments, outputting granular material comprises forcing, by the rotatable member, granular material through a horizontal outlet in an enclosure. In some embodiments, outputting granular material comprises outputting granular material through a hose attached to the outlet. At the outlet, granular material is added to an intermediate composition to a desired cement composition, cement paste, mortar, or dry mixture thereof.

In operation 840, the frame is leveled by adjusting a leveler. In some embodiments, operation 840 is performed before performing any other operation.

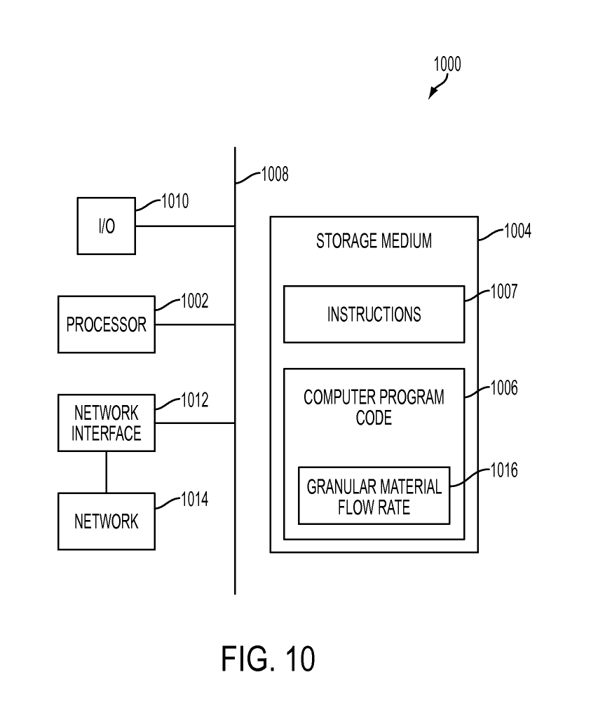

An example embodiment of a method of controlling the dosage of an additive to an intermediate composition is depicted in FIG. 9. Various embodiments include some or all of the operations depicted in FIG. 9.

In operation 910, a feeding apparatus is positioned over an intermediate composition conveyer. In some embodiments, positioning comprises placing a frame on the uppermost components of a portion of the conveyer. In some embodiments, positioning comprises placing a frame and leveler on the uppermost components of a portion of the conveyer. In some embodiments, positioning comprises adjusting the leveler to level the frame.

In some embodiments, granular material is added to an intermediate composition to a desired cement composition, cement paste, mortar, or dry mixture thereof. In some embodiments, the resultant composition is in the form of a shotcrete dry-mix (gunite) having a rheology modifier such as attapulgite (e.g., Acti-Gel® 208). In various embodiments, the feeding apparatus comprises feeder 200, feeder 500, or any of the various embodiments described above.

In some embodiments, the intermediate composition comprises a mixture of cementitious binder and find aggregates (e.g., sand). In some embodiments, cementitious binder and fine aggregates (e.g., sand) are received from hoppers supported by a chassis and mixed at or near the upstream end of the conveyor. In some embodiments, the chassis is a mobile carrier such as a truck or trailer. In some embodiments, the chassis is a stationary support structure.

In operation 920, a user adjusts the rate of flow of the additive from a feeding apparatus outlet into the granular composition. In some embodiments, the user adjusts the rate of flow by providing input to a controller which controls the rate of rotation of a motor in communication with a rotatable member within an enclosure, the rotatable member comprising one or more recesses configured to contain a volume of the additive, or the rotatable member comprising a screw, in accordance with the various embodiments described above.

In operation 930, the additive and intermediate composition are mixed. In some embodiments, the additive and intermediate composition are mixed while being transported by the conveyor from the upstream end to the downstream end of the conveyor. In some embodiments, the additive and intermediate composition are mixed by a screw or auger while being transported by the conveyor from the upstream end to the downstream end of the conveyor.

In some embodiments, the additive and the intermediate composition are mixed with water at or near a nozzle at or near the downstream end of the intermediate composition conveyer. See FIG. 11 for an example of a shotcrete, dry-mix (gunite) procedure. In some embodiments, near the nozzle or near the downstream end of the intermediate composition conveyer ranges from 1 inch to 72 inches or from 6 inches to 48 inches or from 12 inches to 36 inches.

FIG. 10 is a block diagram of a controller 1000 configured for electric motor control in accordance with one or more embodiments. In some embodiments, controller 1000 is similar to controller 130 (FIG. 1). Controller 1000 includes a hardware processor 1002 and a non-transitory, computer readable storage medium 1004 encoded with, i.e., storing, the computer program code 1006, i.e., a set of executable instructions. Computer readable storage medium 1004 is also encoded with instructions 1007 for interfacing with elements of controller 1000. The processor 1002 is electrically coupled to the computer readable storage medium 1004 via a bus 1008. The processor 1002 is also electrically coupled to an I/O interface 1010 by bus 1008. A network interface 1012 is also electrically connected to the processor 1002 via bus 1008. Network interface 1012 is connected to a network 1014, so that processor 1002 and computer readable storage medium 1004 are capable of connecting and communicating to external elements via network 1014. In some embodiments, network interface 1012 is replaced with a different communication path such as optical communication, microwave communication, inductive loop communication, or other suitable communication paths. The processor 1002 is configured to execute the computer program code 1006 encoded in the computer readable storage medium 1004 in order to cause controller 1000 to be usable for performing a portion or all of the operations as described with respect to granular material feeder 100 (FIG. 1), feeder 200 (FIG. 2), feeder 500 (FIG. 5), the method depicted in FIG. 8, and the method depicted in FIG. 9.

In some embodiments, the processor 1002 is a central processing unit (CPU), a multi-processor, a distributed processing system, an application specific integrated circuit (ASIC), and/or a suitable processing unit. In some embodiments, processor 1002 is configured to receive user input related to rate of flow of granular material via network interface 1012. In some embodiments, processor 1002 is configured to generate motor control information signals for transmitting to external circuitry via network interface 1012.

In some embodiments, the computer readable storage medium 1004 is an electronic, magnetic, optical, electromagnetic, infrared, and/or a semiconductor system (or apparatus or device). For example, the computer readable storage medium 1004 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 1004 includes a compact disk-read only memory (CD-ROM), a compact disk-read/write (CD-R/W), and/or a digital video disc (DVD). In some embodiments, the computer readable storage medium 1004 is part of an embedded microcontroller or a system on chip (SoC).

In some embodiments, the storage medium 1004 stores the computer program code 1006 configured to cause controller 1000 to perform the operations as described with respect to granular material feeder 100 (FIG. 1), feeder 200 (FIG. 2), feeder 500 (FIG. 5), the method depicted in FIG. 8, and the method depicted in FIG. 9. In some embodiments, the storage medium 1004 also stores information needed for performing the operations as described with respect to granular material feeder 100, such as a granular material flow rate parameter 1016 and/or a set of executable instructions to perform the operation as described with respect to granular material feeder 100.

In some embodiments, the storage medium 1004 stores instructions 1007 for interfacing with external components. The instructions 1007 enable processor 1002 to generate operating instructions readable by the external components to effectively implement the operations as described with respect to granular material feeder 100.

Controller 1000 includes I/O interface 1010. I/O interface 1010 is coupled to external circuitry. In some embodiments, I/O interface 1010 is configured to receive instructions from a port in an embedded controller.

Controller 1000 also includes network interface 1012 coupled to the processor 1002. Network interface 1012 allows controller 1000 to communicate with network 1014, to which one or more other computer systems are connected. Network interface 1012 includes wireless network interfaces such as BLUETOOTH, WIFI, WIMAX, GPRS, or WCDMA; or wired network interface such as ETHERNET, USB, IEEE-1394, or asynchronous or synchronous communications links, such as RS485, CAN or HDLC. In some embodiments, the operations as described with respect to controller 1000 are implemented in two or more granular material feeders, and information such as granular material flow rate are exchanged between different controllers 1000 via network 1014.

Controller 1000 is configured to receive information related to granular material flow rate from a user or an external circuit. The information is transferred to processor 1002 via bus 1008 and stored in computer readable medium 1004 as granular material flow rate parameter 1016.

During operation, processor 1002 executes a set of instructions to control granular material flow as described with respect to granular material feeder 100 (FIG. 1), feeder 200 (FIG. 2), feeder 500 (FIG. 5), the method depicted in FIG. 8, and the method depicted in FIG. 9.

In some embodiments, the apparatus or method makes it possible to eliminate the need for liquid dispensing of admixtures or the need to pre-mix dry granular additives and water, thus minimizing additional handling and equipment and improving efficiency.

In some embodiments, rather than using conventional application of liquid additives at the gunite nozzle which may decrease the effectiveness of the additive due to incomplete mixing, the gunite feeder dispenses further back (upstream) in the process at the mixing screw conveyor which allows for longer duration of mixing and more complete mixing of the additive into the gunite mix stream.

No other method exists to dispense a dry granular additive material in a shotcrete, dry-mix (gunite) application, making this method unique and highly competitive with liquid dispensing methods.

Additionally, in some embodiments, this device is unique in the dry granular materials handling industry in that the adjustable base provides a means of positioning, leveling and securing the device onto an inclined screw (i.e., “auger”) conveyor, making it adaptable to different metering or mixing chambers and different terrain. This leveling capability permits the device to adapt to varying gunite truck designs by providing a mechanism to quickly adjust between a range of angles from 0° to 35° from a plane parallel to the ground.

In some embodiments, provided is an apparatus for feeding granular material. The apparatus includes a frame comprising a leveler configured to control a horizontal orientation of the frame; a controller; and a feeder secured to the frame. The feeder comprises a hopper; an enclosure comprising an outlet; a drive assembly electrically connected to the controller; and a rotatable member in communication with the drive assembly and configured to rotate within the enclosure to control a rate of flow of the granular material from the hopper through the outlet.

In some embodiments, provided is a method of dispensing granular material. The method comprises receiving, by a feeder comprising a hopper and secured to a frame, granular material from the hopper; rotating, by a drive assembly, a rotatable member within a enclosure of the feeder to control a rate of flow of the granular material from the hopper; outputting the granular material through an outlet in the enclosure; and controlling a horizontal orientation of the frame by adjusting a leveler.

In some embodiments, provided is a method of controlling the dosage of an additive to a granular composition. The method comprises positioning a feeding apparatus over an intermediate composition conveyer; and adjusting, by a user of the feeding apparatus, a rate of flow of the additive from a feeding apparatus outlet into the granular composition. The feeding apparatus comprises a frame; a controller configured to receive user inputs; and a feeder secured to the frame, the feeder configured to control a rate of flow of the additive from a hopper through the outlet in response to the user inputs.

Although the embodiments and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and operations described in the specification. As one of ordinary skill in the art will readily appreciate from the disclosure of the present invention, processes, machines, manufacture, compositions of matter, means, methods, or operations, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or operations.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. An apparatus for feeding granular material, comprising:
a frame comprising a leveler configured to control a horizontal orientation of the frame;
a controller; and
a feeder secured to the frame, the feeder comprising:
a hopper;
an enclosure comprising an outlet;
a drive assembly electrically connected to the controller; and
a rotatable member in communication with the drive assembly and configured to rotate within the enclosure to control a rate of flow of the granular material from the hopper through the outlet.

2. The apparatus of claim 1, wherein the rotatable member is a screw.

3. The apparatus of claim 2, wherein the outlet comprises a tube extending horizontally from the enclosure and the screw is configured to rotate within the tube.

4. The apparatus of claim 1, wherein the feeder further comprises a hose attached to the outlet.

5. The apparatus of claim 1, wherein the frame has a substantially planar shape and the leveler comprises an extension perpendicular to a plane containing the substantially planar shape.

6. The apparatus of claim 5, wherein the extension perpendicular to the plane containing the substantially planar shape is adjustable.

7. The apparatus of claim 5, wherein the extension perpendicular to the plane containing the substantially planar shape comprises a bar.

8. A method of dispensing granular material, comprising:
receiving, by a feeder comprising a hopper and secured to a frame, granular material from the hopper;
rotating, by a drive assembly, a rotatable member within a enclosure of the feeder to control a rate of flow of the granular material from the hopper;
outputting the granular material through an outlet in the enclosure; and
controlling a horizontal orientation of the frame by adjusting a leveler.

9. The method of claim 8, wherein the frame has a substantially planar shape and adjusting the leveler comprises adjusting the length of an extension perpendicular to a plane containing the substantially planar shape.

10. The method of claim 9, wherein adjusting the extension perpendicular to the plane containing the substantially planar shape comprises adjusting a bar.

11. The method of claim 8, further comprising positioning the frame over a conveyer.

12. The method of claim 11, wherein the conveyer comprises topmost components that form an angle relative to the horizontal orientation of the frame, and wherein adjusting the leveler comprises adjusting for an angle that ranges from about 0 degrees to about 20 degrees.

13. The method of claim 8, wherein outputting the granular material through the outlet further comprises outputting the granular material through a hose attached to the outlet.

14. The method of claim 8, further comprising controlling, by a controller, a rate of rotation of a drive assembly motor in communication with the rotatable member to control the rate of flow of the granular material.

15. The method of claim 8, wherein rotating a rotatable member comprises rotating a screw.

16. A method of controlling the dosage of an additive to a granular composition, comprising:
positioning a feeding apparatus over an intermediate composition conveyer; and
adjusting, by a user of the feeding apparatus, a rate of flow of the additive from a feeding apparatus outlet into the granular composition, wherein the feeding apparatus comprises:
a frame;
a controller configured to receive user inputs; and
a feeder secured to the frame, the feeder configured to control a rate of flow of the additive from a hopper through the outlet in response to the user inputs.

17. The method of claim 16, wherein the intermediate composition comprises a dry-mix shotcrete and the additive comprises one or both of a rheology modifier or mix stabilizer.

18. The method of claim 16, wherein the granular composition conveyer is an auger conveyer.

19. The method of claim 16, further comprising mixing the additive and the intermediate composition in the conveyer.

20. The method of claim 16, further comprising adding water to the intermediate composition and additive at a downstream end of the conveyer.
